(19) United States
(12) Patent Application Publication
(10) Pub. No.: US 2007/0089166 A1
(43) Pub. Date: Apr. 19, 2007

(54) Personal passwords management system

(76) Inventor: Timur Medjitov, Toronto (CA)

Correspondence Address: GEORGE ROLSTON AND ASSOCIATES, SUITE 900, 45 SHEPPARD AVENUE EAST, TORONTO, ON, M2N 5W9, CA

(21) Appl. No.: 11/514,830

(22) Filed: Sep. 5, 2006

(30) Foreign Application Priority Data
Oct. 14, 2005 (CA) 2,524,971

(51) Int. Cl. H04L 9/32

(52) U.S. Cl. 726/5

(57) ABSTRACT

The present invention provides a Personal Passwords Management System: PPMS. PPMS combines a method for the selection of an infinite number of unique and highly secure passwords and a simple and secure method of password retrieval. PPMS represents a collection of symbols in a form of tables or any other geometrical figures pre-populated with random symbols (a letter, number, or other characters). To select new passwords and later to retrieve created passwords, a user of PPMS first needs to define a password signature and then compare it with the appropriate password table. Password signature is a geometric pattern based on the type of password table used in the PPMS, including its orientation. Thus, by using one or several password signatures a user manages strong, secure passwords for any number of resources.

### FIELD OF THE INVENTION

The present invention relates generally to a personal passwords management system.

### BACKGROUND OF THE INVENTION

Due to the enormous growth in the information technologies sector, Internet and the industry of electronic products, the number of users of these technologies and products for the last several decades has been growing as well. A huge amount of Internet resources, software applications, personal computers and devises, corporate networks and their users led to the requirement of granting of personalized access to these resource by means of personal passwords. As a consequence, there has emerged a need for a way to manage the personal passwords by the users on the one hand, and by the providers of these services and systems on the other hand. This invention relates mostly to the commonly known problem of managing personal passwords by the users of various services and systems. From this point on, we use a notion of a resource to describe any service or system requiring from a user a password-based access to them.

People in the modern society more and more often have to create and use personal passwords to access various resources. Good examples of the resources that require the use of personal passwords are the on-line home banking and other popular Internet resources such as e-mail service, personal computers and devices, home appliances, various secured commercial resources and communication systems, such as wireless telephones.

Theoretically, for an average person, with the growth of the number of the resources, the number of unique passwords for these resources should grow proportionally. Unfortunately, in reality this is not always the case. One of the major problems leading to security breaches and personal account intrusions remains the fact that users very often do not use unique, strong personal passwords to have an access to their resources. More specifically:
1. Passwords are not strong and often simple to guess.
2. The same password is used to access different resources.
3. Passwords are not changed frequently.

We believe that the major reason for this is the lack of a simple and convenient mechanism for managing personal passwords.

Currently available methods and systems offer one of the following solutions:
1. Software-based password systems for managing personal passwords.
2. Passwords management outsourcing to the third-party companies.
3. Some recommendations and rules as to how to select different passwords.
   None of these solutions is perfect, however and each suffers from a number of critical disadvantages.

In the first case, the main drawback of the solution is some degree of physical ‘attachment’ to a particular software system, which limits its availability to the user. This approach requires a constant access of the user to the specific software system, which limits its utility in many everyday situations. In addition, this approach may require knowledge of the software application, as well as software support and regular updates, with possible extra costs.

In the second case, the transfer of the password management to a third party can compromise security and privacy. The third party companies can themselves experience security breaches, causing the loss of personal information of their customers.

The limitation of the third approach is that it is only suitable for a small number of passwords and become progressively impractical with an increase of the number of passwords a user has to manage.

The best password is the one that does not follow any obvious patterns and is easy to remember for the person but difficult for anyone else to guess. The growth of the number of resources requiring passwords requires generation of ever-growing number of passwords by each user. The available automated password-generating software programs and other techniques are available that enable intruders to crack poorly constructed password protection. Thus there is a growing and currently unmet need for a user-friendly, simple and secure password management system.

### BRIEF SUMMARY OF THE INVENTION

This simple and convenient personal passwords management system is based on the following requirements:
1. The system should allow a user to select strong (secure) passwords.
2. The system should allow an easy change of passwords.
3. The system should be able to generate new passwords based on any set of symbols.
4. The system should be mobile in terms of accessibility.
5. The system should be easy to use and maintain.

As the password tables are filled with random symbols, all personal passwords generated by this method are strong and hard to guess. ‘Strong password’ in this context means a password that should include upper and lower-case letters as well as numbers and other symbols. Also, PPMS allows the handling of passwords based on different sets of symbols, which makes it very flexible. For example, a website might require a use of passwords based on numbers only or based on alphanumeric symbols without using any other symbols. Another example would be a situation when a user often needs to use passwords based on different alphabets, let's say French and Spanish, without the knowledge of any of these alphabets. These requirements could be easily accommodated by using appropriate groups of password tables and password signatures. Further, by changing the password signature regularly, it's easy to select new passwords for the recourses using the same collection of password tables. This feature makes the problem of changing passwords regularly quite trivial.

### IN THE DRAWINGS

Embodiments of this invention will now be described by way of example in association with the accompanying drawings, in which:

FIG. 1 illustrates the invention in the form of a PPMS of six password tables;

FIGS. 2 through 5 illustrate different types of password tables and password signatures;

FIG. 6 is a general flowchart diagram showing main steps in selecting a new password; and

FIG. 7 is a general flowchart diagram showing main steps in retrieving a password.

### DESCRIPTION OF THE PREFERRED EMBODIMENT

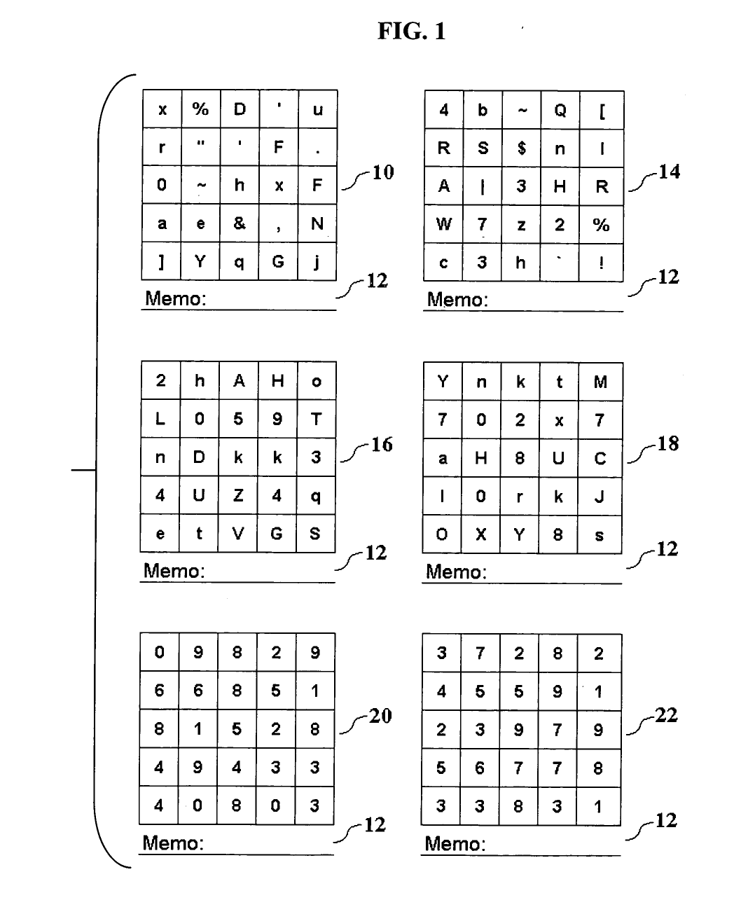

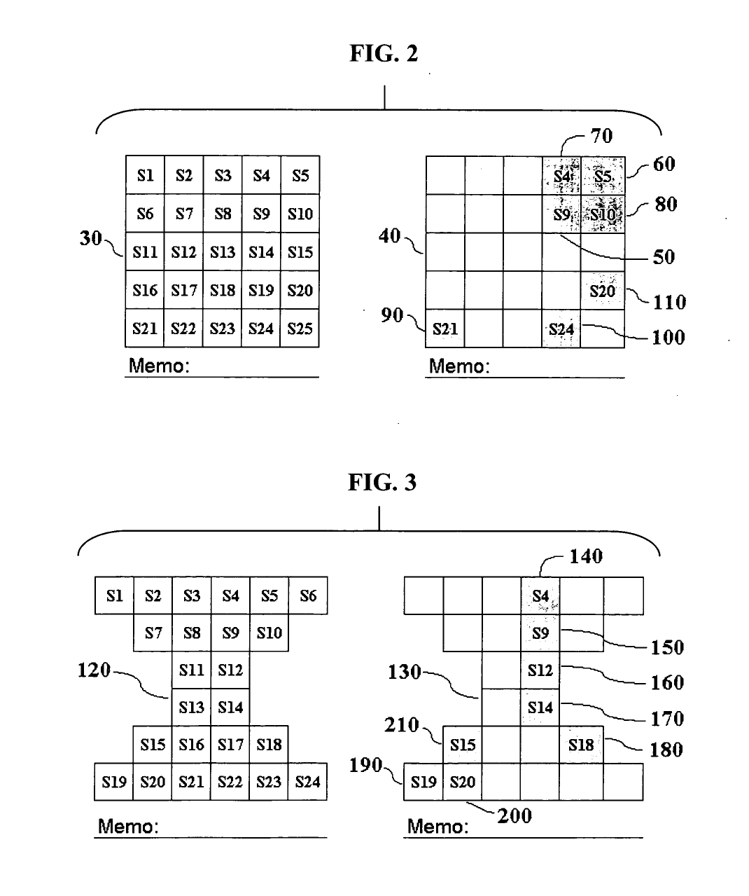

Referring first to FIG. 1, a personal passwords management system, comprising a collection of password tables (10), (14), (16), (18), (20) and (22). The password tables are in the form of squares five by five in this case. According to the preferred embodiment of the present invention all of these password tables are filled with the random symbols. To illustrate some of the possible scenarios, (10) and (14) are filled with alphanumeric and other symbols; (16) and (18) are filled with alphanumeric; (20) and (22) are filled with numbers only. (12) is a memo field that is used for specifying a name of the resource. A resource name could be a name of a website or e-mail address, name of a computer or an indication to a home security system. In the preferred embodiment, there is a one-to-one relationship between a password table and a corresponding resource, and one password table manages one password at a time. In practice, as one of the options, all password tables within PPMS could be sorted by memo fields in alphabet order or, password tables could be grouped in several categories based on the common meaning of the corresponding resources or some other criteria. A user constructs a password signature illustrated in FIG. 2 that comprises a geometric pattern, based on the same type of password table that is used within the system and plus some specific orientation. Thus, if the PPMS consists of password tables (30), FIG. 2, the password signature for this PPMS must also be constructed based on the same type of password tables. FIGS. 2 through 5 illustrate different examples of password tables and password signatures. A geometric pattern representing the password signature dose not have to be a continuous range, but rather not an obvious one and not simple to guess. It is recommended to use password signatures and therefore personal passwords of length not less than seven elements (symbols). As the notion of password signature also includes its geometric orientation, which makes it even more difficult to guess in case someone else obtains the access to the user's password management system. By using a proper password table type, like squares five by five, it's not difficult to construct and remember a password signature in the form of geometric pattern and then, by comparing it with one of the password tables, to identify the actual password. As an example, in FIG. 2 the order of elements (50), (60), (70), (80), (90), (100) and (110) defines the signature's orientation (40) for the representative password table (30). Similarly, (140), (150), (160), (170), (180), (190), (200) and (210) defines the signature's orientation (130) for a representative password table (120) of PPMS illustrated in FIG. 3; (240), (250), (260), (270), (280), (290) and (300) defines the signature's orientation (230) for a representative password table (220) of PPMS illustrated in FIG. 4; (330), (340), (350), (360), (370), (380), (390) and (400) defines the signature's orientation (320) for a representative password table (310) of PPMS illustrated in FIG. 5. The comparison of the password signature (40), FIG. 2, with the password tables (14), (18) and (22) in FIG. 1, shows the actual passwords (not including the quote marks) “n[Qlc'%”, “xMt7O8J” and “9281338” accordingly.

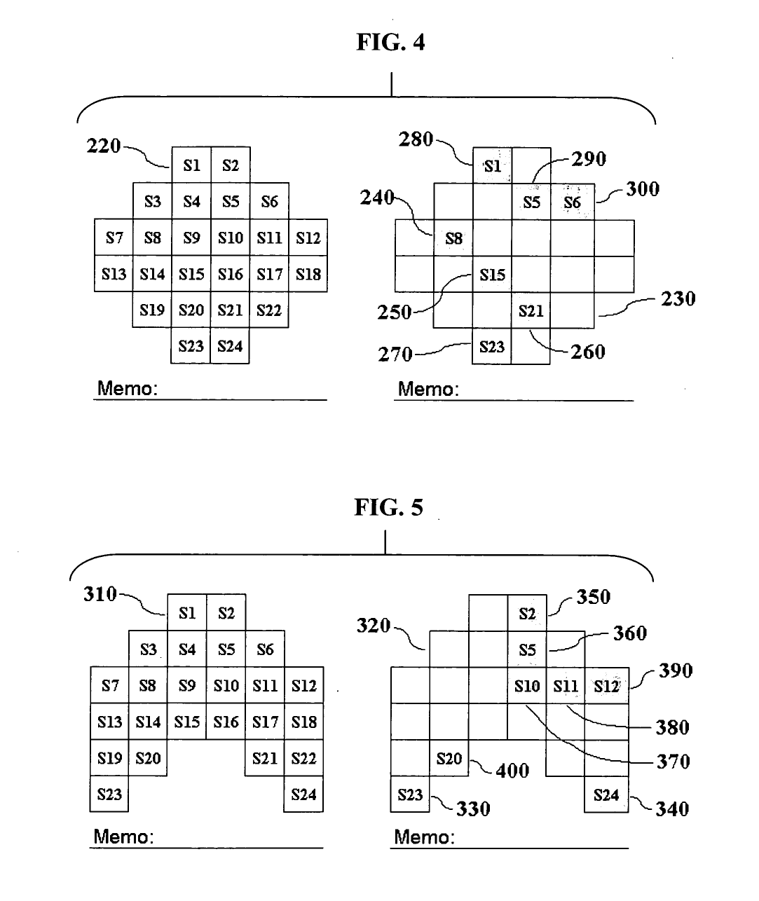

Referring now to FIG. 6, a general flowchart is shown of the preferred method of the present invention for selecting personal passwords. Before using the personal passwords management system a user first defines a password signature at the step (410). At the step (420), a user establishes association between any one of the available password tables with some particular resource. This is done by using the memo fields where the names of the resources are specified. These first two steps make the system ready to select new passwords for any password table and thus for the corresponding resources. At the step (430), a new password is selected by comparing the password signature with the resource's password table.

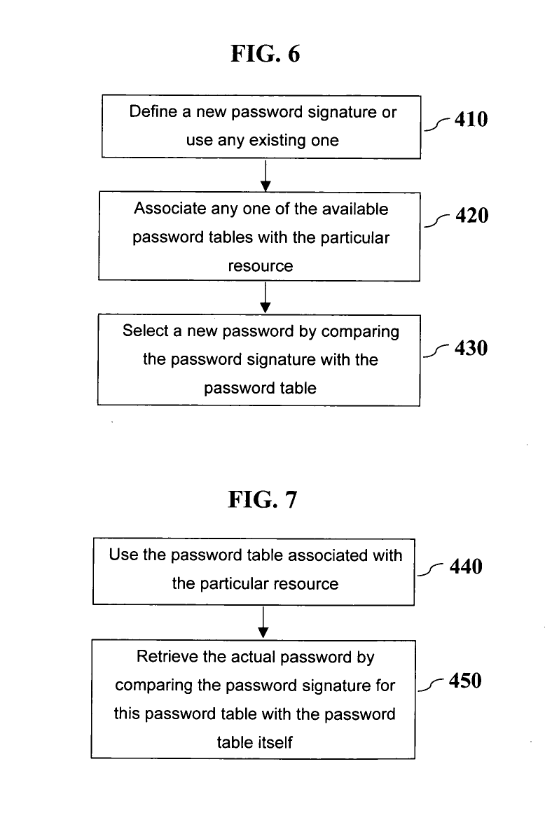

Referring now to FIG. 7, a general flowchart is shown of the preferred method of the present invention for retrieving personal passwords. At the step (440) a user refers to the password table associated with the particular resource. It is easy to do by looking at the memo field attached to each password table. At the step (450) the actual password is retrieved by comparing the password signature for this password table with the password table itself.

A preferred method of the present invention for changing personal passwords for several resources at once consist in changing the password signature used for the password tables associated with these resources. A preferred method of the present invention for changing a personal password for just one resource at a time consist in establishing a new association between this resource and some of the available password tables. There is no need to define a new password signature in this case. In practice this can be accomplished by crossing out or eliminating the password table used for the resource and selecting the appropriate password table that is not associated with any of the resources managed by PPMS.

In accordance with the preferred embodiment of the present invention, one of the implementations of the personal passwords management system could be in the form of a personal notebook. Such a personal password notebook is convenient to carry and handle. The passwords are only easy to decipher by using the proper password signature that is known only to the user.

Due to the general nature of the system and methods for managing personal passwords described above, the very same system and methods can be used to manage other types of secure information. As an example, a user can utilize PPMS to manage not only personal passwords, but also user identification names (user ids).

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A personal passwords management system comprises:
a collection of geometric figures for the implementation of the system;
random symbols based on one or several sets of characters, in respective figures.

2. The personal passwords management system as claimed in claim 1 and wherein each of the figures called password table, manages one password and has an attached memo field for the user to specify a particular resource.

3. The personal passwords management system as claimed in claim 2 and wherein one group of these password tables has alphanumeric and other symbols, and an other group has just alphanumeric, and a third group has numeric symbols only.

4. The personal passwords management system as claimed in claim 1 and wherein passwords management system is in the form of a personal notebook or a simple software program or a spreadsheet without any need to keep the actual passwords in the database or other repositories, and therefore making it accessible to the user, especially being in the form of a compact personal notebook.

5. The method of making a personal passwords management system using password tables within a password protected system, by selecting at least one password signature, and keeping it either in memory or in a secure place; using at least one signature to select new passwords for all resources, whereby a collection of password tables and at least one personal password signature is required for such systems.

6. The method as claimed in claim 5 including establishing an association between password tables and some target resources by specifying the resource names in memo fields associated with respective password tables.

7. The method as claimed in claim 5 including comparing a password signature with a password table enables to select and later retrieve a password, which is in the form of the password signature, thereby allowing managing a large number of passwords by using at least one password signature.
